(19) United States
(12) Patent Application Publication
(10) Pub. No.: US 2007/0044840 A1
(43) Pub. Date: Mar. 1, 2007

(54) MOTOR ACTUATED WALL HYDRANT

(75) Inventor: William T. BALL, Colorado Springs, CO (US)

Correspondence Address: ZARLEY LAW FIRM P.L.C., CAPITAL SQUARE, 400 LOCUST, SUITE 200, DES MOINES, IA, 50309-2350, US

(73) Assignee: WCM INDUSTRIES, INC., Colorado Springs, CO (US)

(21) Appl. No.: 11/161,938

(22) Filed: Aug. 23, 2005

(51) Int. Cl. F16L 5/00

(52) U.S. Cl. 137/360

(57) ABSTRACT

A wall hydrant assembly with a faucet head mounted to an exterior wall of a building and connected to an outlet pipe that extends through the exterior wall to a motor located in an interior area. An inlet pipe is connected to a water supply at one end and the motor at the other. A power means is operatively connected to the motor for controlling the motor to allow the flow of water from the water supply to the faucet head when energized.

### BACKGROUND OF THE INVENTION

The present invention relates to wall faucets or hydrants and more specifically to a means of controlling the flow of fluid through a wall hydrant.

Wall hydrants are well known in the art and include a variety of parts to control the flow of water from a water supply. Further, the delivery tube or outlet pipe of present wall hydrants must be of a rigid material and be of a predetermined length in order to contribute to the function of the faucet and ensure that the valve seat of the faucet is positioned in an area of the interior of the house where it is remote from outside freezing conditions.

Because the control mechanisms are contained at each faucet head, multiple parts are required which can add to the installation expense. Further, the need for a rigid material of a predetermined length also adds to the expense and flexibility of installation. Because of these problems, a need exists for a simpler device to control the flow of water to a wall hydrant that is easy and economical to manufacture and install.

An objective of the present invention is to provide a wall hydrant that has a minimum number of parts.

A further objective of the present invention is to provide a wall hydrant that is economical to manufacture.

A still further objective of the present invention is to provide a wall hydrant that is easy to install and operate.

### BRIEF SUMMARY OF THE INVENTION

A wall hydrant is provided having a faucet head that is mounted to the exterior wall of a building. Connected to the faucet head, and extending through the exterior wall, is an outlet pipe. Connected to a water supply is an inlet pipe. Positioned inside the exterior wall and connected between the outlet and inlet pipes is a motor that controls the flow of water from the water supply to the faucet head. The motor is controlled by a power means.

### BRIEF DESCRIPTION OF THE DRAWINGS

FIG. 1 is a perspective view of the present invention;

FIG. 2 is a perspective view of the present invention assembled in a building; and

FIG. 3 is a perspective view of the present invention assembled in a building with centralized motor and power means.

### DESCRIPTION OF THE PREFERRED EMBODIMENTS OF THE INVENTION

Referring to the figures, the wall hydrant assembly of the present invention is designated generally by the number 10. The assembly includes a faucet head 12 mounted to the exterior wall 14 of a building. Connected to the faucet head 14 is an outlet pipe 16 that extends through the exterior wall 14 of the building to an interior area 18 of the building.

Within the interior area 18 is an inlet pipe 20 that is connected to a water supply (not shown). Within the interior area is a motor 22 that connects the inlet pipe 20 to the outlet pipe 16. The motor 22 can be of any conventional type, electrical or otherwise, that prevents the flow of water when at a state of rest and allows water to flow when energized. Preferably, the motor 22 is powered by a conventional circuit breaker 24.

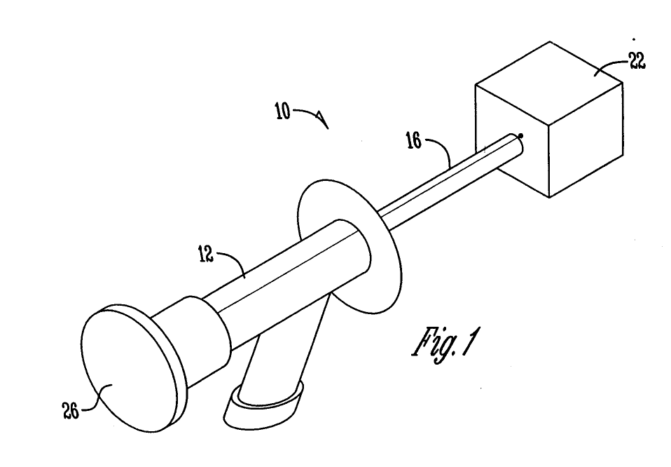

The motor 22 is controlled by a power means that energizes the motor to allow water to flow through the outlet pipe 16 to the faucet head 12 and de-energizes the motor 22 to prevent water from flowing into the outlet pipe 16 to the faucet head 14. In one embodiment, the power means includes a switch 26 mounted on the faucet head 12 and electrically connected to the motor 22 as shown in FIG. 1.

In another embodiment, the power means includes a switch mounted to the faucet head 12 that transmits an actuating signal to a receiver (not shown) within the motor 22. While these embodiments are shown as examples, other embodiments having a remote switch that transmits a signal via phone or computer are included. Also, a central box with electronic timers to actuate the motor 22 is included.

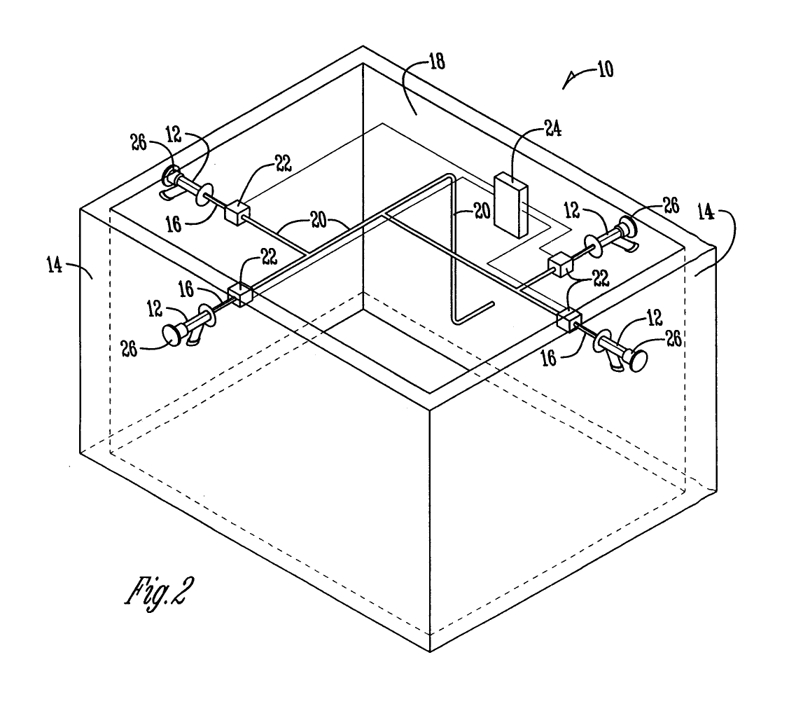

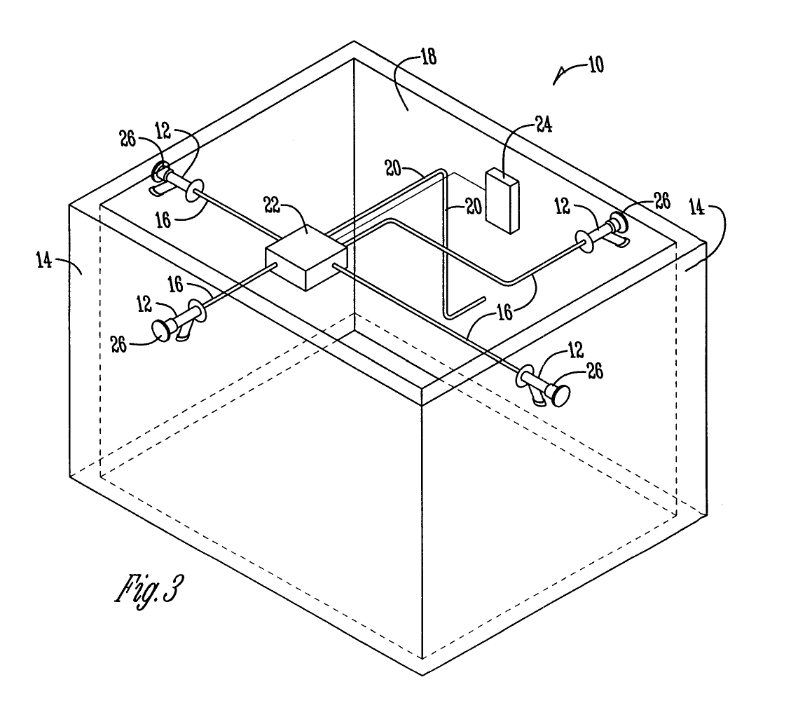

For ease in installation, an operator can locate the motor 22 in a central location, as shown in FIG. 3, or at other locations within the interior area 18 of the building that are convenient for repair and maintenance (see FIG. 2). When centrally located, the motor 22 can be energized such that fluid flows independently through the various outlet pipes to the faucet heads, thereby allowing fluid to flow only through desired faucet heads.

The wall faucet assembly 10 can be adapted to a sprinkler system by attaching existing sprinkler heads (not shown) to the faucet heads 12. Such a system is easily winterized by unscrewing the sprinkler heads from the faucet heads 12.

As can be seen, the present assembly eliminates many of the parts used with a traditional wall hydrant. This invention eliminates the need for a handle screw, wheel handle, packing nut, packing, packing support washer, valve stem, check valve, valve seat, and retainer screw. Instead, water flow is controlled solely by the motor 22.

In addition, because the outlet pipe 16 is only used to deliver water, rather than contribute to the fluid control function of the motor, the outlet pipe 16 can be made of less rigid and more economical materials. Further, the outlet pipe can be of different lengths. Presently, specified lengths are required to ensure that the valve seat rests in an area of the building that is remote from outside freezing conditions. Because weather conditions vary throughout the country, the valve stem assembly must be made in different lengths along with the corresponding outlet pipe. With the elimination of traditional wall hydrant parts and the ability to position the motor 22 anywhere in the interior area 18, no standardized length is required for the outlet pipe 16.

Having described the present invention, it can be seen that it achieves the stated objectives by eliminating parts, thus reducing costs, and providing a device that is easy to install and operate. Having described the preferred embodiment, it will become apparent that various modifications can be made without departing from the scope of the invention, as defined in the accompanying claims.

What is claimed is:

1. A wall hydrant assembly mounted to an exterior wall of a building with a closed interior, comprising:
a faucet head mounted on the exterior wall of the building; an outlet pipe connected to the faucet head and extending through the exterior wall of the building to the closed interior;
an inlet pipe located in the interior of the building connected to a water supply;
a motor positioned inside the exterior wall and connected to both the outlet pipe and inlet pipe to allow the flow of water from the water supply to the faucet head when energized; and
a power means operatively connected to the motor for controlling the same.

2. The assembly of claim 1 wherein the power means comprises a switch mounted on the faucet head and electrically connected to the motor.

3. The assembly of claim 1 wherein the power means comprises a switch mounted on the faucet head that transmits an actuating signal to a receiver within the motor.

4. A wall hydrant assembly mounted to an exterior wall of a building with a closed interior, comprising:
a plurality of faucet heads mounted on the exterior wall of the building;
a plurality of outlet pipes connected to the faucet heads and extending through the exterior wall of the building to the closed interior;
an inlet pipe located in the interior of the building connected to a water supply;
a motor positioned inside the exterior wall and connected to both the outlet pipes and inlet pipe to allow the flow of water from the water supply to the faucet heads when energized; and
a power means operatively connected to the motor for controlling the same.

5. The assembly of claim 4 wherein the power means comprises a plurality of switches mounted on the faucet heads and electrically connected to the motor.

6. The assembly of claim 4 wherein the power means comprises a plurality of switches mounted on the faucet heads that transmit actuating signals to a receiver within the motor.
